(19) United States
(12) Patent Application Publication
(10) Pub. No.: US 2020/0132241 A1
(43) Pub. Date: Apr. 30, 2020

(54) DEVICE FOR PREPARING LINER FOR PIPE

(71) Applicant: Picote Solutions Oy Ltd, FI-06450 Porvoo (FI)

(72) Inventor: Mika Lokkinen, Porvoo (FI)

(21) Appl. No.: 16/493,411

(22) PCT Filed: Mar. 9, 2018
(86) PCT No.: PCT/IB2018/051540

§ 371 Date: Sep. 12, 2019

(30) Foreign Application Priority Data
Mar. 22, 2017 (FI) 20175269

(51) Int. Cl. F16L 55/18; F16L 55/165

(52) U.S. Cl. CPC F16L 55/18; F16L 55/1651

(57) ABSTRACT

The device is for preparing a liner to be installed in a pipe. The device has a frame, which is rotationally symmetrical in relation to its rotational axis. The frame has two ends, in the middle of both of which ends is arranged an opening. The device further has two rings in connection with the frame, which are equally large in their outer diameter. The outer diameter is larger than the outer diameter of the frame in the section between the rings.

### FIELD OF THE INVENTION

The invention relates to a device for spreading epoxy evenly into a liner used in pipe renovations.

### PRIOR ART

The pipes in real estate properties are, increasingly more often, renovated by the so-called CIPP (Cured-in-Place Pipe) method, in which inside the pipes is installed an epoxy-saturated liner, which is slid into the pipe by the inversion method using air pressure. Before installation, the outer surface of the liner is formed by an impenetrable plastic membrane and the inner surface by an absorbent material, usually felt or fabric. Into the liner is introduced epoxy in liquid form and the liner is mangled until the epoxy has spread and soaked evenly into the inside surface of the liner, after which the liner is reeled into a CIPP lining drum. In inversion, compressed air in the CIPP lining drum causes the inside of the liner in the CIPP lining drum to invert in the pipeline as the outer surface of the liner, wherein the epoxy in the outer surface adheres to the inner surface of the pipe. Once the liner is fully inverted from the CIPP lining drum into the pipe, air pressure is maintained until the epoxy has cured and the liner forms a new pipe inside the old pipe.

A disadvantage in the arrangement are the mangles according to prior art, which are heavy and require electricity to function, thus they are to be fixedly installed. Preparation of the liner must then be performed in a car or a worksite container, into which the mangle is installed.

### BRIEF DESCRIPTION OF THE INVENTION

The object of the invention is a device, which decreases the disadvantages of mangles according to prior art.

The invention is based on a cylinder, the distance of which from a planar surface can be formed as desired by the rings in the cylinder. A device according to the invention has a cylindrical frame, onto which are arranged, spaced apart from each other, rings larger in radius than the radius of the cylinder. The part of the cylinder remaining between the rings forms against the planar surface a gap that is the size of the difference between the radius of the rings and the radius of the cylinder. Using the device, the epoxy inside the liner can be spread into an even layer, for example, by placing the liner onto the planar surface and rolling the device on the liner such that the liner is between the rings of the device. Alternatively, the device can be rotated in place such that the rings are against a rotatable or freely rotating cylinder, wherein the liner, running between the portion of the frame between the rings of the device and the second cylinder, is evened out to the thickness defined by the gap of the rings.

### BRIEF DESCRIPTION OF THE FIGURES

The invention is now described in more detail in connection with preferred embodiments, with reference to the accompanying drawings, in which:

FIG. 1 shows a device according to one embodiment, in which the rings are arranged onto the surface of the frame;

FIG. 2 shows a device according to one embodiment, in which the rings are arranged to the ends of the frame;

FIG. 3 shows a device according to one embodiment, which is equipped with a handle;

FIG. 4 shows a device according to one embodiment in connection with the second cylinder.

### DETAILED DESCRIPTION OF THE INVENTION

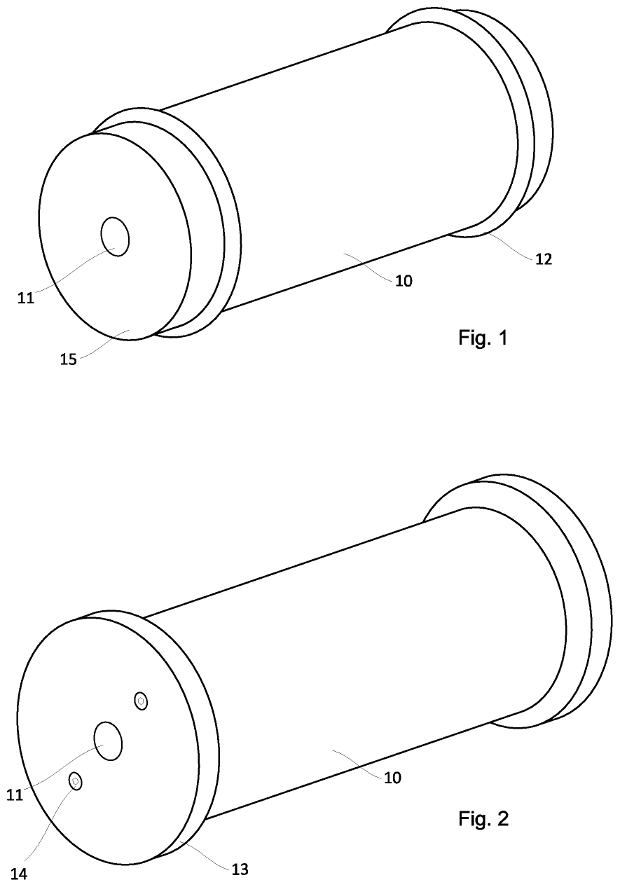

FIG. 1 shows a device according to one embodiment of the invention, which is composed of a rotationally symmetrical, cylindrical frame 10 and rings 12 on the surface of the frame 10. In the middle of both ends 15 of the frame 10 are round openings 11, from which the device can, for example, be bearing-mounted or into which can be fastened a handle for pushing the device or a crank for rotating the device. The openings 11 can also be in connection with each other, wherein it is a case of a hole extending through the entire frame 10. Into the frame 10 can be arranged grooves around the frame at the rings 12, wherein the groove contributes to the rings 12 remaining in place on the frame 10. The surface of the frame 10 is preferably even, with the exception of the possible grooves arranged for the rings.

The frame 10 is preferably manufactured from plastic, wood, metal or a combination of the above. The rings 12 can be a fixed part of the frame, or detachably attached to the frame 10. In one embodiment, there are grooves in the surface of the frame 10 for the rings 12, and the rings are manufactured from rubber, silicon or other elastic material in order that they can be slightly stretched when installing into place, and having settled into the grooves, the rings 12 return to their original form and remain in place in the grooves. The rings 12 preferably also have nonslip surfaces, for example of rubber or silicon, wherein the device can easily be rolled against a planar surface, rather than that the device would slide against the planar surface. Sliding of the device might damage a liner that is being handled, thus it is preferable that the coefficient of sliding friction of the rings is high, causing rolling of the device instead of sliding, for example, when the device is moved against a planar surface.

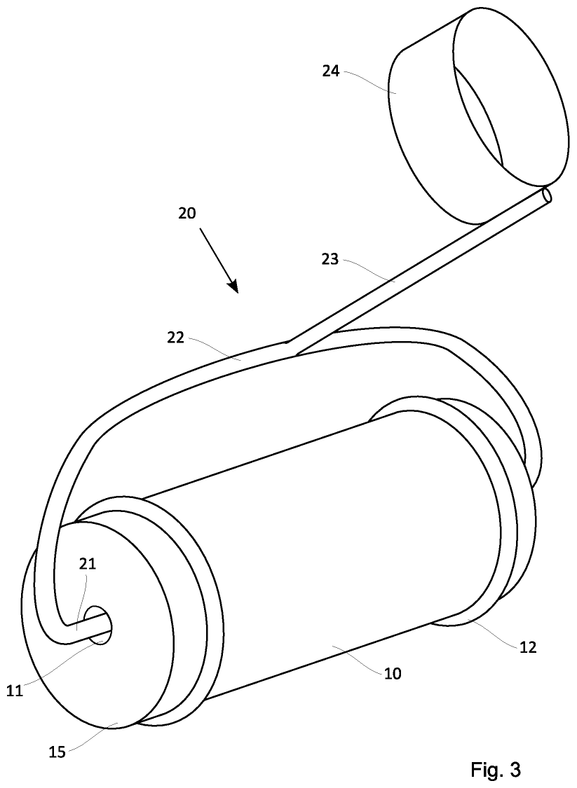

FIG. 2 shows a device according to one embodiment of the invention, composed of a rotationally symmetrical, cylindrical frame 10 and disc-like rings 13 in the ends 15 of the frame 10. The rings 13 can be a fixed part of the frame 10, or they can be detachably attached to the frame 10, for example, with screws 14. Both in the middle of the rings 13 and in the middle of both ends 15 of the frame 10 are round openings 11, from which the device can, for example, be bearing-mounted or into which can be fastened a handle for pushing the device or a crank for rotating the device. In one embodiment, the frame 10 is a completely solid and uniformly thick cylinder and the openings 11 are only in the middle of the rings 13, which are fastened to the ends 15 of the frame 10. The openings 11 of the frame can also be in connection with each other, wherein it is a case of a hole extending through the entire frame 10. The surface of the frame 10 is preferably even, with the exception of the possible grooves arranged for the rings.

The frame 10 is preferably manufactured from plastic, wood, metal or a combination of the above. The rings 13 can be a fixed part of the frame, or detachably attached to the frame 10. The outer surface on the circumference of the rings 13 is preferably covered with, coated with or manufactured from, for example, rubber, silicon or other material having a nonslip surface, wherein the device can easily be rolled against a planar surface, rather than that the device would slide against the planar surface. Sliding of the device might damage a liner that is being handled, thus it is preferable that the coefficient of sliding friction of the rings is high, causing rolling of the device instead of sliding, for example, when the device is moved against a planar surface.

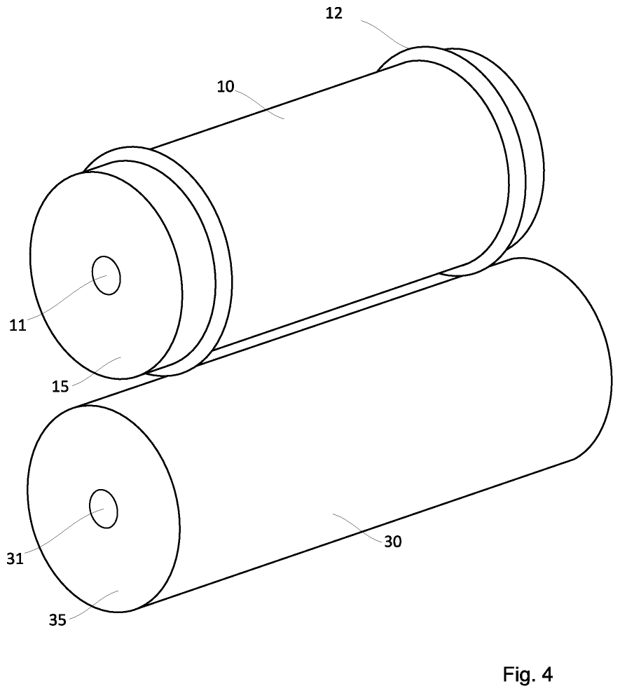

FIG. 3 shows a device according to the embodiment shown in FIG. 1, which further has a handle 20 for using the device with one hand. An equivalent handle can also be used in connection with a device according to the embodiment shown in FIG. 2. The handle 20 is preferably detachably attached to the frame. The handle 20 has two axis parts 21 parallel to the rotational axis of the frame 10, which are adapted to be inserted into the openings 11 in the ends 15 of the frame 10. Bearings can be used in the outermost ends of the axis parts 21 of the handle to decrease friction between the axis part 21 and the frame 10. The handle 20 further has a frame part 22 linking the axis parts 21, which is, in its entirety, outside the frame. The handle 20 further comprises a support part 23 connected to the frame part 22, which is preferably transverse in relation to the rotational axis of the frame 10. The handle 20 further comprises, in connection with the support part 23, an elbow support 24, which can be, for example, the shape of a ring or pipe. The handle 20 is preferably manufactured from metal, such as steel, in order to achieve adequate stiffness and resiliency. In one embodiment, the handle 20 can be detached from the frame by pulling the outermost end of the handle 20 away from the frame 10 in the direction of the rotational axis of the frame 10, wherein the axis part 21 rises away from the opening 11 of the frame, and the handle 20 is released. Correspondingly, the handle 20 can be attached to the frame by pulling the axis parts 21 further from each other, placing the axis parts at the openings 11 of the frame, and releasing the grasp from the handle, wherein the axis parts 21 protrude into the openings 11 of the frame. Because the distance between the free ends of the axis parts 21, when the handle is in the resting position, is less than the length of the frame 10, the handle 20 does not detach from the frame 10 other than by pulling the axis parts 21 further from each other.

In one embodiment, the axis parts 21 of the handle are bolts and the openings 11 of the frame 10 are threaded to receive the thread of the bolt of the axis part and bearing-mounted in relation to the frame. Other corresponding manners of connection allowing rotational movement can also be used between the frame and the handle.

The embodiment shown in FIG. 3, which comprises a frame 10, rings 12 and a handle 20, can be used with one hand to spread epoxy inside a liner. The hand is inserted through the elbow support 24 such that the wrist and part of the forearm remain against the support part 23 and, by grasping with the palm, a hold is taken from the connection point of the support part 23 and the frame part 22. The elbow support 24 assists the leverage effect produced by the support part 23 in order to create an adequate force for pressing the device against the planar surface in order that the rings 12 remain against the planar surface and the liner to be levelled remains between the rings as well as between the frame 10 and the planar surface. As the planar surface can be used almost any level surface, such as a floor, table, worktop, or even a wall. The hand remaining free can, for example, move, correct or hold in place the liner, while, using the device, the epoxy inside the liner is rolled into an even layer.

FIG. 4 shows the device according to the embodiment shown in FIG. 1 in connection with a counter-cylinder 30. A corresponding arrangement can also be used in connection with the device according to the embodiment shown in FIG. 2. Both the cylindrical frame 10 of the device and the counter-cylinder 30 are rotatably fastened to the support structure, for example, by axes from the openings 11 of the ends 15 of the frame 10, and from the openings 31 of the ends 35 of the counter-cylinder 30 such that their rotational axes are parallel and at the desired distance from each other. Neither the fastening to the support structure nor the support structure is shown in FIG. 4. The distance between the rotational axes is preferably exactly as great or nearly as great as the sum of the radius of the ring 12 in connection with the frame 10 and the radius of the counter-cylinder 30. The distance can deviate from said sum of the radii, for example, by less than 5%, less than 10% or less than 15%. In one embodiment, both the frame 10 and the counter-cylinder 30 are fastened to rotate freely around their rotational axes. In one preferred embodiment, to the frame 10 and/or counter-cylinder 30 are connected rotational means for rotating it/them. In one embodiment, the rotational means can be a crank, by which the frame and/or counter-cylinder can be manually rotated. In one embodiment, the rotational means can be an angular peg, by which the frame and/or counter-cylinder can be rotated by a power drill or an electric screwdriver by connecting the angular peg into the chuck of the drill or the screwdriver, or manually using, for example, an adjustable wrench, box wrench, open-ended wrench or ring wrench as an aid for grasping the angular peg.

It is obvious to the skilled person in the art that, as technology develops, the basic idea of the invention can be implemented in various ways. The invention and its embodiments are therefore not limited to only the examples presented above, rather they may vary within the scope of the claims.

I claim:

1. A device for preparing a liner to be installed in a pipe, the device comprising:
a frame, which is rotationally symmetrical in relation to a rotational axis of the frame, the frame having two ends (15), in the middle of both of which ends is arranged an opening,
two rings in connection with the frame, which are equally large in an outer diameter of the two rings and said outer diameter being larger than the outer diameter of the frame in a section between the two rings,
to each end of the frame is fastened one ring of said two rings, the two rings having an outer diameter being 5-30 mm larger than the outer diameter of the frame in the section between the two rings, and a handle for using the device with one hand.

2. The device according to claim 1 wherein said rings comprise rubber or silicon on an outer surface of the rings to prevent slippage.

3. The device according to claim 1 wherein said two rings are detachably attached to the frame and arranged as interchangeable with rings of different size in outer diameters of the two rings in order to achieve a clearance.

4. The device according to claim 1 wherein said handle comprises two axis parts parallel to the rotational axis of the frame, which are adapted to be inserted into the openings in the ends of the frame;
a frame part linking the axis parts;
a support part connected to the frame part, which is transverse in relation to the rotational axis of the frame; and
an elbow support in connection with the support part.

5. The device according to claim 4 wherein said elbow support of the handle has a shape of a ring or pipe, having an outer diameter and an inner diameter, wherein the inner diameter of the elbow support is, at a narrowest point of the elbow support, at least 50 mm.

6. The device according to claim 4 wherein at least the axis parts of the handle and the frame part are manufactured at least partially from steel.
